(19) United States
(12) Patent Application Publication
(10) Pub. No.: US 2026/0316770 A1
(43) Pub. Date: Oct. 15, 2026

(54) VEHICLE CONTROL DEVICE

(71) Applicant: Hitachi Astemo, Ltd., Hitachinaka-shi, Ibaraki (JP)

(72) Inventor: Ryosuke SHIMIZU, Hitachinaka-shi (JP)

(73) Assignee: Hitachi Astemo, Ltd., Hitachinaka-shi, Ibaraki (JP)

(21) Appl. No.: 19/101,342

(22) PCT Filed: Dec. 20, 2022
(86) PCT No.: PCT/JP2022/046807

§ 371 Date: Feb. 5, 2025

(51) Int. Cl. B60W 50/02; B60W 10/06; B60W 10/18; B60W 10/20; B60W 30/09; B60W 50/12

(52) U.S. Cl. CPC B60W 50/0205; B60W 10/06; B60W 10/18; B60W 10/20; B60W 30/09; B60W 50/12

(57) ABSTRACT

A vehicle control device stops a vehicle control function and generates analysis data when detecting a supply voltage drop, and records the analysis data in a nonvolatile memory at any of timing of eliminating an abnormality due to a detection of a voltage rise, timing when a duration of the voltage drop reaches a certain period of time or longer, timing when the vehicle control function with which damage of a power supply system is predicted is performed within a certain period of time until the vehicle control function is stopped, and timing when the vehicle control function in which a large voltage fluctuation occurs is performed within a certain period of time until the vehicle control function is stopped.

### TECHNICAL FIELD

The present invention relates to a vehicle control device that stores information to be used for analysis of an abnormality factor relating to a vehicle.

### BACKGROUND ART

A known conventional technique is a technique with which, quick and proper maintenance and repair are enabled in a vehicle control device (see, for example, PTL 1 below). Such maintenance and repair are performed by self-diagnosing an abnormal state of a vehicle (own vehicle), storing data for analysis effective for analyzing a cause of abnormality occurrence in a nonvolatile memory when an abnormality of the vehicle is detected, and easily estimating the cause of abnormality occurrence with reference to the data for analysis.

### CITATION LIST

### Patent Literature

PTL 1: JP 2014-231305 A

### SUMMARY OF INVENTION

### Technical Problem

However, in the above conventional technique, since the capacity in which data for analysis (hereinafter, it may be referred to as analysis data) can be stored is limited, only the data for analysis effective for analyzing the cause of abnormality occurrence has to be accurately maintain. If the analysis data is stored one after another under a situation the data is unnecessary for analysis, analysis data is pushed out and overwritten by new analysis data. In a case where analysis data is necessary, analysis data during abnormality occurrence that is originally desired to be resolved cannot be obtained, and time and effort are taken to identify the cause of the abnormality occurrence.

In particular, when a problem arises in a power supply system such as an in-vehicle battery or a generator, the vehicle control device determines a drop of a supply voltage to stop a vehicle control function, records the analysis data, and uses the analysis data for repair and maintenance. However, the supply voltage drops similarly when a driver turns off the power of the vehicle. Since an operation for turning off the power of the vehicle by the driver is performed on a daily basis, if the drop of the supply voltage is detected and the analysis data is stored, analysis data during abnormality occurrence that is originally desired to be resolved cannot be obtained.

On the other hand, if the condition for storing the analysis data is too strict when the supply voltage drop, there is a conflict such that information cannot be stored as the analysis data when a problem arises in the power supply system.

Further, in recent years, in order to improve preventive safety and convenience of vehicles, vehicles have been advanced and motorized. External recognition sensors such as a camera, a radar, and a sonar are also connected to the power supply system of the vehicles, and motorized actuators, such as an electric power steering and an electric parking brake are also increasing. Charge-discharge characteristics of the power supply system change depending on a type, presence or absence of equipment, a production lot, and the like of each component, and the time between a power-off operation by a driver and a voltage drop varies from 1 [ms] to 200 [ms].

In a vehicle control device that provides automated driving, collision reduction automatic braking, and automatic steering avoidance, these devices connected to the same power supply system are combined and operated in cooperation. Therefore, the vehicle control needs to be provided only when all the devices can appropriately operate. The vehicle control has to be immediately stopped when an abnormal voltage drop is detected. On the other hand, there is difficulty such that erroneous recording of analysis data has to be prevented by a power-off operation by a driver similarly even in vehicles having different charge-discharge characteristics. This causes a problem such that parameters need to be adjusted in accordance with the charge-discharge characteristics in order to cope with a new vehicle type or a combination of parts.

Further, the vehicle control device performs brake control or the like for the purpose of avoiding an accident, but there are cases where a detection cannot be made by a sensor due to an influence of weather or the like, and where braking control cannot exert a target deceleration force due to an influence of a traveling road surface condition. In addition, also in a case where a functional failure due to a voltage drop occurs during control for the purpose of accident avoidance, there is a case where an operation in which the accident avoidance control is degraded is performed and thus the accident avoidance performance cannot be delivered. In such cases, an accident cannot be avoided, and a ground fault occurs in the power supply system of the own vehicle due to a collision of the own vehicle with a three-dimensional object such as a wall or a peripheral vehicle. As a result, the operation of an in-vehicle electronic device is stopped, and a failure has been detected immediately before the accident occurrence, that is, important analysis data cannot be left.

The present invention has been made in view of the above problems, and an object of the present invention is to provide a vehicle control device that accurately records analysis data when an abnormal voltage drop is detected, prevents erroneous storage of analysis data by a power-off operation by a driver, memory extrusion caused by unnecessary analysis data when analyzing an abnormality of the vehicle, and can obtain analysis data during abnormality occurrence, the analysis data being most useful for investigating a cause of the abnormality occurrence without necessary analysis data loss caused by push-out from a memory due to unnecessary analysis data.

### Solution to Problem

In order to solve the above problems, a vehicle control device that controls an own vehicle by performing control functions achieved by a plurality of control devices that shares one power supply includes a voltage measurement unit that measures a voltage of the power supply, an abnormality diagnosis unit having a control stop function of determining whether the control functions achieved by the plurality of control devices are difficult to perform due to a voltage drop of the power supply and stopping the control in a case where functions are difficult to perform, and a storage instruction unit that instructs a storage unit to store history information indicating a stop phenomenon of an operation in the control stop function. The storage instruction unit instructs the storage unit to store the history information in a case where a voltage of the power supply becomes higher than a predetermined voltage at which the control functions are difficult to perform after the control stop function is performed.

### Advantageous Effects of Invention

According to the vehicle control device of the present invention, analysis data is accurately recorded when an abnormal voltage drop is detected, and erroneous storage of analysis data due to a driver's power-off operation can be prevented. Then, when abnormality of the vehicle is analyzed, analysis data during abnormality occurrence, the analysis data being most useful for investigating a cause of the abnormality, can be obtained without necessary analysis data loss caused by push-out from a memory due to unnecessary analysis data.

Problems, configurations, and effects other than those described above will be clarified by the following description of embodiments.

### BRIEF DESCRIPTION OF DRAWINGS

FIG. 1 is a block diagram illustrating a system configuration of a vehicle to which a vehicle control device according to an embodiment of the present invention is applied.

FIG. 2 is a functional block diagram of the vehicle control device according to an embodiment of the present invention.

FIG. 3 is a flowchart of vehicle control processing executed by the vehicle control device according to an embodiment of the present invention.

FIG. 4 is a flowchart of voltage drop diagnosis processing.

FIG. 5 is a flowchart of event data recorder processing.

FIG. 6 is a flowchart of event data recorder processing for a normal state.

FIG. 7 is a flowchart of event data recorder processing for voltage drop abnormality.

FIG. 8 is a flowchart of event data recorder processing for voltage drop abnormality (in response to power supply defect).

Hereinafter, a vehicle control device according to an embodiment of the present invention will be described with reference to the drawings.

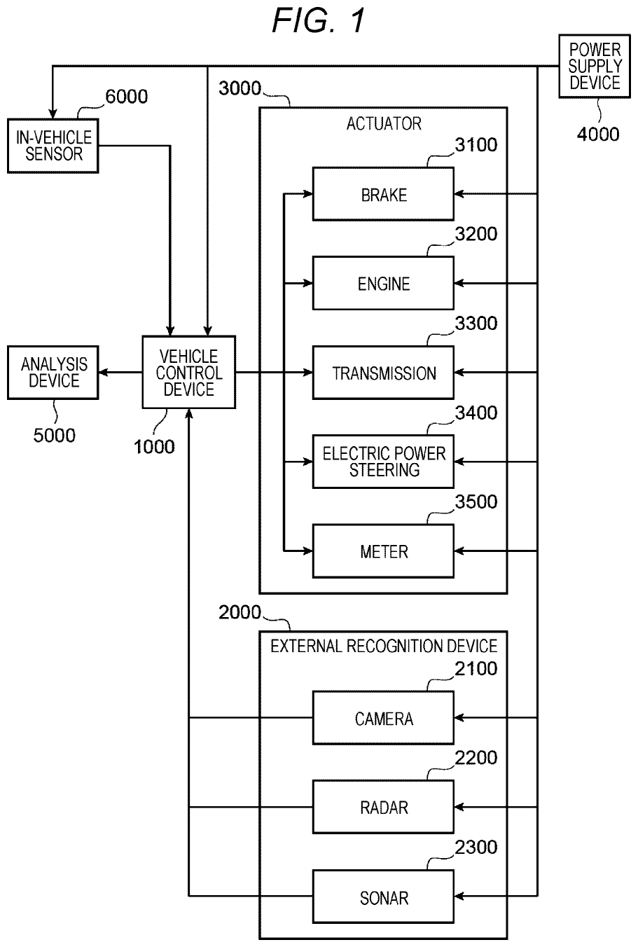

FIG. 1 illustrates a system configuration of a vehicle to which the vehicle control device according to an embodiment of the present invention is applied. A vehicle control device 1000 acquires information from an external recognition device 2000 installed to an own vehicle, and instructs an actuator 3000 installed in the own vehicle to control the own vehicle in accordance with an acquired result.

The following four examples will be described as vehicle control functions provided (performed) to control the own vehicle.

Example 1 provides adaptive cruise control (ACC) with which the vehicle control device 1000 calculates a longitudinal acceleration of the own vehicle to support the travel of the own vehicle while maintaining a safe and comfortable distance with respect to a preceding vehicle using information about a position with the preceding vehicle acquired by a camera 2100 which is a part of the external environment recognition device 2000 and information about the position with respect to the preceding vehicle acquired by a radar 2200, and automatically controls a brake 3100 and an engine 3200 which are parts of the actuator 3000 to support brake and accelerator operations of a driver.

Example 2 provides autonomous emergency braking (AEB) with which, similarly to the ACC, the vehicle control device 1000 calculates a risk of collision with an own vehicle based on a position of a three-dimensional object such as a pedestrian acquired by the camera 2100 or the radar 2200, gives a visual warning and an acoustic warning to a driver using a meter 3500 which is a part of the actuator 3000 in accordance with an acquired result, and automatically controls the brake 3100 when the collision risk becomes higher to avoid and reduce the collision damage. Further provided is automatic emergency steering (AES) that controls the electric power steering 3400 in order to avoid a collision by setting an orientation of the own vehicle to a direction where no three-dimensional object exist after determining that the collision cannot be avoided only by the control of the brake 3100.

Example 3 provides a lane keeping steering (LKS) with which the vehicle control device 1000 acquires a roadway outside line position of an own vehicle travel lane (own lane) using the camera 2100, calculates a yaw rate or a steering angle position of the vehicle so that the own vehicle can travel on a center with respect to right and left roadway outside lines, that is, a center position of the own lane, and controls a direction of the own vehicle in a right-left direction using the electric power steering 3400 which is a part of the actuator 3000 based on a calculation result to reduce a driving load caused by driver's steering.

In Example 4, when an own vehicle is stopped at a stop, a driver instructs the vehicle to stop when the own vehicle approaches a stop position, and the own vehicle starts automatic stop travel. In the automatic stop travel, a stop position of the own vehicle is detected by the camera 2100, and a determination is made whether to collide with surrounding obstacle or a surrounding stopped vehicle based on the detection result of the sonar 2300. The direction and position of the own vehicle are controlled using the brake 3100, the engine 3200, a transmission 3300, and the electric power steering 3400. The driver completes the stop without operating a brake pedal, an accelerator pedal, a steering, and a shift lever. An automatic stop function of notifying the driver that the stop is completed using the meter 3500 is provided.

In order to perform the vehicle control functions described in the examples, the camera 2100, the radar 2200, and the sonar 2300 are illustrated as the external recognition device 2000, and the brake 3100, the engine 3200, the transmission 3300, the electric power steering 3400, and the meter 3500 are illustrated as the actuator 3000. However, in order to perform various vehicle control functions, various types of sensing devices and communication devices, such as a global positioning system (GPS), a vehicle-to-vehicle communication device, a road-to-vehicle communication device, an illuminance sensor, and a rain sensor, may be provided as the external recognition device 2000. Conversely, the external recognition may be performed using only the camera 2100 without the radar 2200 and the sonar 2300. Thus, an infinite number of combinations of the devices exist. Further, as the actuator 3000, the vehicle control device 1000 of the present embodiment can be applied to an electric vehicle. The vehicle control device 1000 gives control instructions for operations of lights such as a headlight, a blinker, and a brake lamp, a wiper, a door lock, an air conditioner, an audio device, a device for communication with a call center, and the like, that is the operations other than stop, making a turn, and travel of the vehicle, and controls a driving force of the own vehicle using a motor without the engine 3200 and the transmission 3300.

Furthermore, the vehicle control device 1000 acquires information regarding a driving operation of the driver and a motion state of the own vehicle, such as information regarding an operation amount of the accelerator pedal and the travel speed of the own vehicle, from an in-vehicle sensor 6000 mounted in the own vehicle in addition to the external recognition device 2000 and the actuator 3000, and uses the acquired information for processing of performing feedback as to the ACC vehicle speed control. This achieves a more comfortable vehicle control function.

The vehicle control device 1000 then performs information processing and communication with each in-vehicle device by being supplied with electric power from a power supply device 4000 mounted in the own vehicle. Similarly, the external recognition device 2000, the actuator 3000, and the in-vehicle sensor 6000 are also configured to be able to perform sensing and actuation by being supplied with power from the power supply device 4000, and provide driving support functions such as ACC, AEB, AES, and LKS to the driver as vehicle control functions. That is, the vehicle control device 1000, the external recognition device 2000, the actuator 3000, and the in-vehicle sensor 6000 share the same power supply device 4000, and receive power supply from the same power supply device 4000.

Further, the vehicle control device 1000 is connected to communicate with the external recognition device 2000, the actuator 3000, and the in-vehicle sensor 6000, and performs self-diagnosis whether the vehicle control device 1000 itself is normal while diagnosing whether the external recognition device 2000, the actuator 3000, and the in-vehicle sensor 6000 are normal based on communicated information. Then, in a case where an abnormality of the devices (1000, 2000, 3000, 4000, and 6000) necessary for performing the vehicle control functions is detected by various diagnoses, the driving support function of the vehicle control functions is quickly degenerated, and the driving operation is entrusted to the driver. As a result, the own vehicle is prevented from falling into dangerous behavior such as brake control and occurrence of steering based on an erroneous sensing result.

Further, the vehicle control device 1000 records information in the vehicle control device 1000 as analysis data when abnormalities are detected by various diagnoses. A vehicle maintenance person or a person in charge of analysis acquires and refers to the analysis data by connecting an analysis device 5000 to the vehicle control device 1000 during analysis of a cause of the abnormalities or repair, thereby understanding a situation during the abnormality detection and enabling appropriate and prompt maintenance.

Next, details of the vehicle control device 1000 will be described. The vehicle control device 1000 is a control device that operates by being supplied with power, and includes an arithmetic device configured by a microprocessor, a communication terminal for performing data communication, a power supply circuit, a read only memory (ROM) in which information about a program executed by a central processing unit (CPU) is recorded, a volatile memory (random access memory (RAM)) for holding a processing result of the program while the power is on, and a nonvolatile memory for holding the arithmetic result also when the power is off.

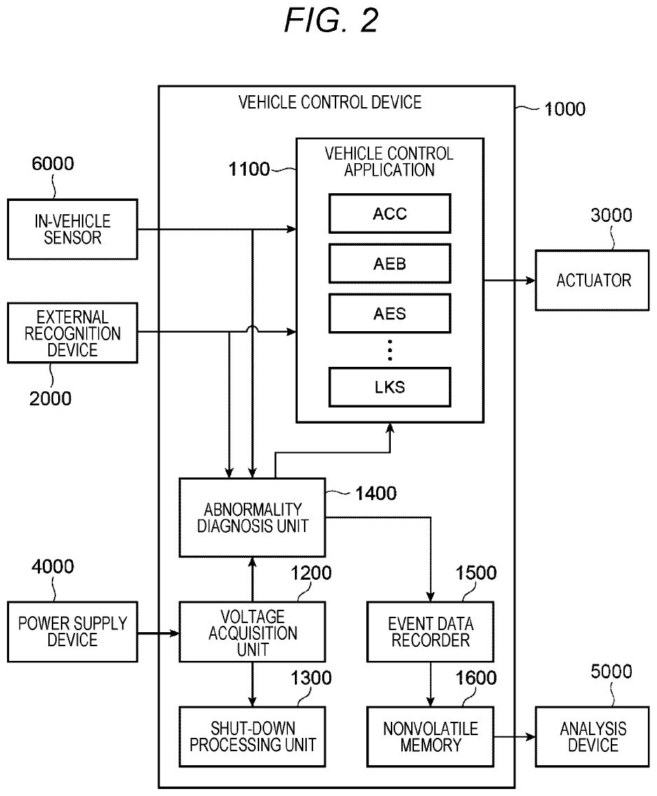

Further, the functions provided by the vehicle control device 1000 are illustrated in FIG. 2. Using the information acquired from the external recognition device 2000 and the in-vehicle sensor 6000, the vehicle control device 1000 causes a vehicle control application 1100 to process a control amount for making vehicle control in accordance with the vehicle control functions, such as ACC, AEB, AES, and LKS, and makes the vehicle control by giving a control instruction to the actuator 3000.

The vehicle control device 1000 receives power supply from the power supply device 4000, and causes a voltage acquisition unit 1200 to acquire a supply voltage supplied from the power supply device 4000. When the supply voltage acquired by the voltage acquisition unit 1200 becomes lower than a shutdown voltage threshold, a shutdown processing unit 1300 operates to turn off the power of the vehicle control device 1000. An abnormality diagnosis unit 1400 determines whether the supply voltage acquired from the voltage acquisition unit 1200 is lower than a voltage drop determination threshold set to be higher than the shutdown voltage threshold, and detects an abnormality caused by the voltage drop when the supply voltage is lower than the voltage drop determination threshold. Further, the abnormality diagnosis unit 1400 diagnoses whether the vehicle control function can be correctly performed using the information acquired by the communication from the external recognition device 2000 and the in-vehicle sensor 6000 and internal information about the vehicle control device 1000, and instructs the vehicle control application 1100 to degenerate or stop the vehicle control function when a supply voltage drop, an abnormality of the communication, or an internal abnormality is detected. In the present embodiment, the abnormality diagnosis unit 1400 has a control stop function of determining whether the supply voltage acquired from the voltage acquisition unit 1200 is lower than the voltage drop determination threshold (a predetermined voltage that makes it difficult to perform the vehicle control function), that is, whether the vehicle control function is difficult to perform due to (an abnormality caused by) a voltage drop of the power supply device 4000, and stopping the control when function is difficult to perform.

When the abnormality diagnosis unit 1400 detects an abnormality due to the voltage drop, the event data recorder 1500 collects information (for example, history information indicating a stop phenomenon of an operation by the control stop function due to the abnormality caused by the voltage drop) useful for analysis of the cause of the abnormality as analysis data (also referred to as event data), and records the collected information in a nonvolatile memory 1600. The event data recorded in the nonvolatile memory 1600 is acquired by the analysis device 5000 connected to the vehicle control device 1000, and analysis data during abnormality occurrence is provided to a vehicle maintenance person or a person in charge of analysis to assist the analysis of the cause of abnormality.

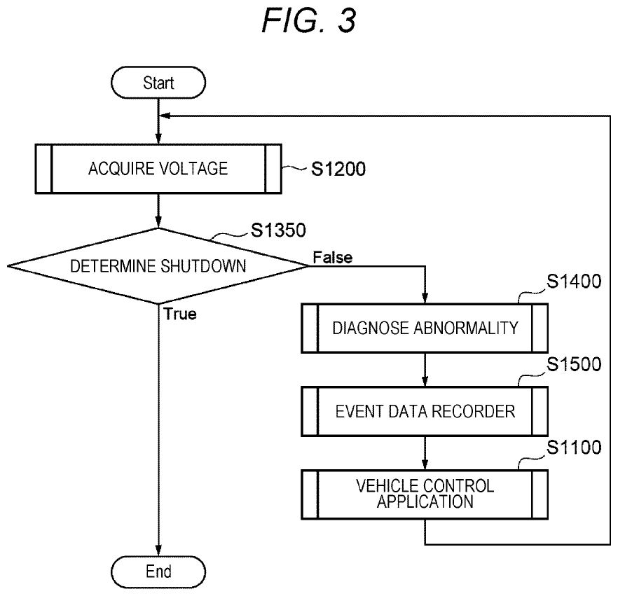

Next, a flow of the entire program (vehicle control processing) executed by the vehicle control device 1000 will be described with reference to the flowchart of FIG. 3.

When being activated by receiving power from the power supply device 4000, the vehicle control device 1000 executes the processing described in the flowchart at Start. First, in voltage acquisition processing S1200, a voltage value (supply voltage) input from the power supply device 4000 is acquired. Next, in shutdown determination processing S1350, a determination is made that a driver has performed a power-off operation of the own vehicle with reference to the supply voltage acquired in the voltage acquisition processing S1200. When the determination is made that the power-off operation has been performed, that is, when the determination is made that shutdown is necessary, the shutdown determination processing S1350 is established, and the vehicle control device 1000 stops the operation of the program and continues the operation stop state of the program until power is turned on again to prevent an increase in power consumption. On the other hand, when the shutdown determination processing S1350 is not established, abnormality diagnosis processing S1400 is executed, and a diagnosis is made whether the vehicle control function is normally operated or no abnormality exists. At this time, in the abnormality diagnosis processing S1400, the voltage drop diagnosis is made, and power is supplied such that the external recognition device 2000, the actuator 3000, and the in-vehicle sensor 6000 necessary for the processing of the vehicle control device 1000 and the vehicle control application 1100 can perform expected operations, and a diagnosis is made whether the voltage is maintained. Thereafter, a determination is made whether a voltage drop abnormality is detected (whether the vehicle control function is difficult to perform due to (the abnormality caused by) a voltage drop).

Event data recorder processing S1500 is executed, and in a case where an abnormality including the result of the voltage drop diagnosis is detected in the determination in the abnormality diagnosis processing S1400 (the vehicle control function is difficult to perform due to (the abnormality caused by) the voltage drop), information (for example, history information indicating a stop phenomenon of the operation in the control stop function due to the abnormality caused by the voltage drop) useful for analyzing the cause of abnormality is stored in the non-volatile memory 1600 as analysis data (FFD).

Next, by executing vehicle control application processing S1100, processing of the vehicle control functions such as ACC, AEB, AES, and LKS is executed, and a control amount to be transmitted to the actuator 3000 and a signal of a control state are generated and calculated. At this time, when the diagnosis result in the abnormality diagnosis processing S1400 is a result indicating an abnormality, the calculation result of each vehicle control function is replaced with a value such that acceleration and deceleration control or steering control operation of the vehicle is not performed by the actuator 3000 (control is stopped) in accordance with the type of the abnormality. In addition, a visual warning signal or an acoustic warning signal for detecting an abnormality for the driver and indicating that the vehicle control function cannot be used or is limited is selected and transmitted to the actuator 3000. This makes it possible to notify the driver of a situation where driver's driving assistance cannot be provided by the vehicle control application 1100, to cause the driver to take an action to move the vehicle to a maintenance factory for repair, and to prevent vehicle acceleration and deceleration control that is not intended by the driver under an environment where sensing and actuation cannot be stably performed due to a voltage drop.

When the vehicle control application processing S1100 is completed, the processing returns to the voltage acquisition processing S1200, and the processing from the voltage acquisition processing S1200 to the vehicle control application processing S1100 are repeatedly performed at regular intervals, for example, at 0.01 [s] intervals. This repetition is performed until the shutdown determination processing S1350 is established and the vehicle control device 1000 executes the shutdown processing, that is, during the period in which the power of the vehicle control device 1000 is on. This makes it possible to provide the driver with appropriate vehicle control in accordance with the external recognition result and the state of the own vehicle that change by the hour.

Next, detailed contents of each function and processing illustrated in the flowchart of FIG. 3 will be sequentially described.

First, the details of the voltage acquisition processing S1200 will be described. In the voltage acquisition processing S1200, the voltage supplied from the power supply device 4000 to the power supply circuit of the vehicle control device 1000 is converted from an analog value to a digital value by allowing the voltage to pass through an AD converter. As a result, the voltage is acquired as a value that can be processed by the microprocessor. Furthermore, the voltage input to the vehicle control device 1000 changes such as being attenuated by passing through the power supply circuit in the vehicle control device 1000, and the voltage value obtained from the AD converter is different from the voltage value input to the vehicle control device 1000. Therefore, a transformation function of the voltage value that is changes by passing through the power supply circuit is inversely operated to be able to be processed as the voltage value input to the vehicle control device 1000. This makes it is possible to diagnose the voltage while estimating whether the power supplied from the power supply device 4000 to the external recognition device 2000, the actuator 3000, and the in-vehicle sensor 6000 is also appropriate.

Next, the shutdown determination processing S1350 will be described. In shutdown determination processing S1350, a determination is made that a driver has performed a power-off operation of the own vehicle with reference to the voltage value acquired in the voltage acquisition processing S1200. Specifically, a shutdown voltage threshold for determining that the power-off operation has been performed, for example, a value of 5 [V] is set in the ROM in advance, and a determination is made that the voltage value acquired in the voltage acquisition processing S1200 is smaller than the shutdown voltage threshold, thereby establishing the shutdown determination.

Next, the abnormality diagnosis processing S1400 will be described. The abnormality diagnosis processing S1400 is a function of diagnosing whether (the vehicle control function of) the vehicle control application can be safely executed. The contents of the diagnosis differ depending on the contents of the vehicle control application 1100 applied to the vehicle control device 1000. For example, in a case where ACC is applied, information acquired from the camera 2100 needs to be correct, and first, a diagnosis is made whether the camera 2100 has a failure. Regarding the failure of the camera 2100, a result of self-diagnosis by the camera 2100 is transmitted to the vehicle control device 1000, and when the result indicates failure, a diagnosis is made that the camera 2100 has a failure. Further, a determination is made that the data to be transmitted from the camera 2100 cannot be received for a certain period of time, and that counter information to be incremented for each transmission, the counter information being added to the data transmitted from the camera 2100, continues the same value. In such a way, the failure of the camera 2100 is detected. A similar mechanism is performed on the radar 2200, the brake 3100, and the engine 3200 to diagnose whether a failure has occurred in a device and a component necessary for performing ACC or a failure has not occurred in a communication path thereof. In addition, a state of function stop, which is not enough to be detected as a failure but has a problem in performing ACC, is diagnosed. For example, if ACC is executed in a situation where the field of view of the camera 2100 is blocked by bad weather such as rain or dense fog, and the position of a preceding vehicle cannot be correctly measured, it is dangerous since correct brake operation cannot be performed on the preceding vehicle, and ACC should be deactivated. Therefore, by scanning an image acquired from the camera 2100 for a difference in density between pixels to detect deterioration of the image, the function stop due to a recognition situation of the camera 2100 is diagnosed, and abnormality detection is performed. In addition, a situation in which various functions and performance necessary for executing ACC cannot be exhibited is determined as the function stop diagnosis in such a manner that a function stop due to a high temperature of a brake pad is diagnosed by sensing that correct brake control cannot be performed due to a temporary temperature rise of the brake pad. A self-diagnosis is made whether the vehicle control device 1000 on which the abnormality diagnosis processing S1400 is executed can correctly operate in addition to the camera 2100 and the brake 3100. Also, in the self-diagnosis, a determination is made whether each element, electric circuit, and the like in the vehicle control device 1000 operate correctly by making a failure diagnosis, for example, a diagnosis as to whether reading and writing of data in the nonvolatile memory 1600 are possible or contents of the data are appropriate, a diagnosis as to whether exchange of electric signals with the communication terminal is possible, or the like. A temperature sensor provided in the vehicle control device 1000 diagnoses whether the temperature is higher than an operation guarantee temperature of the microprocessor or the electric circuit, and when the temperature is higher, makes a determination that the function stop is necessary and detects an abnormality. In the abnormality detection in the function stop diagnosis in the high temperature detection, when a decrease in a temperature is detected, the function stop may be cancelled to enable a normal determination. Further, the abnormality diagnosis processing S1400 includes voltage drop diagnosis processing S1410 for diagnosing whether the power that enables the vehicle control device 1000 to correctly operate is supplied by diagnosing a drop of the voltage supplied to the vehicle control device 1000 and whether the external recognition device 2000, the actuator 3000, and the in-vehicle sensor 6000 can correctly operate by receiving the power supply from the power supply device 4000 similarly to the vehicle control device 100.

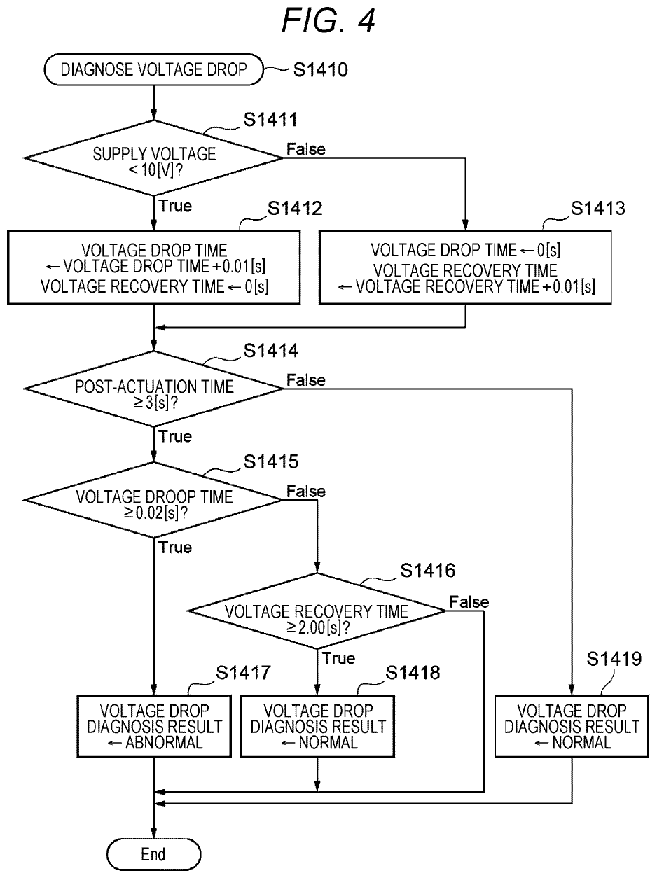

The voltage drop diagnosis processing S1410 will be described in detail with reference to a flowchart of FIG. 4. The voltage drop diagnosis processing S1410 is a diagnosis for detecting occurrence of an abnormality (voltage drop) in any power supply system of the power supply device 4000, a harness for supplying power from the power supply device 4000 to the vehicle control device 1000, and the power supply circuit of the vehicle control device 1000.

In the voltage drop diagnosis processing S1410, first, a determination is made in determination S1411 whether the supply voltage is less than a threshold (voltage drop determination threshold) for determining the voltage drop as an abnormality, for example, 10 [V]. When the condition as to whether the supply voltage is less than 10 V is established in determination S1411, a value corresponding to the execution cycle (for example, 0.01 [s]) is added to a voltage drop time in the processing S1412, and 0 [s] is set as a voltage recovery time. When the condition is not established in the determination S1411, 0 [s] is set as the voltage drop time in the processing S1413, and the value corresponding to the execution cycle is added to the voltage recovery time. Using the determination S1411, the processing S1412, and the processing S1413, a period during which the supply voltage is less than 10 V is defined as the voltage drop time, and a period during which the supply voltage is 10 V or more is defined as the voltage recovery time.

Next, a determination S1414 is made. The vehicle control device 1000 constantly measures the time (post-activation time) since the vehicle control device 1000 is turned on, and determines whether the time after activation has elapsed 3 [s] or more in the determination S1414. When the post-activation time has not elapsed 3 [s] or more in the determination S1414, the condition is not established, and a normal value is set to the voltage drop diagnosis result in processing S1419. When the post-activation time has elapsed 3 [s] or more in the determination S1414, the condition is established, and the voltage drop time is determined in a determination S1415. In the determination S1415, a determination is made whether the voltage drop time updated in the processing S1412 and the processing S1413 exceeds a voltage drop determination time threshold (for example, 0.02 [s] ) or more. When the voltage drop time is equal to or longer than the voltage drop determination time threshold, the condition in the determination S1415 is established, and processing S1417 is executed to set a value indicating an abnormality in the voltage drop diagnosis result. When the condition in the determination S1415 is not established, a determination S1416 is executed to determine the voltage recovery time. In the determination S1416, a determination is made whether the voltage recovery time has exceeded a voltage recovery determination time threshold (for example, 2 [s] ) or more. When the voltage recovery time is equal to or greater than the voltage recovery determination time threshold, the condition in the determination S1416 is established, and processing S1418 is executed, to set a value indicating a normality in the voltage drop diagnosis result. When the condition in the determination S1416 is not established, the voltage drop diagnosis result is not updated, a value obtained when the voltage drop diagnosis is made one cycle before is held. When the value indicating an abnormality is set in the voltage drop diagnosis result, a value indicating abnormality is held, and when a value indicating normality is set in the voltage drop diagnosis result, a normal value is held. In this way, a determination is made how to update or hold the value of the voltage drop diagnosis result, and the voltage: drop diagnosis processing S1410 is ended. When the voltage drop diagnosis result indicates an abnormality, the occurrence of the abnormality is detected with the voltage drop diagnosis in the abnormality diagnosis processing S1400.

In the voltage drop diagnosis processing S1410, by making the determination S1414 of the post-actuation time, the abnormality is not detected as the voltage drop diagnosis result until a certain period of time elapses after a driver performs the power-on operation of the own vehicle. In many cases, immediately after the driver performs the power-on operation of the own vehicle, the power supply to each in-vehicle component is temporarily reduced or cut off in order to turn a cell motor for starting the engine. When each in-vehicle component is sequentially turned on, the power consumption changes, and the voltage supplied to the vehicle control device 1000 tends to be unstable. Furthermore, a case where deterioration of an in-vehicle battery progresses and a situation where the temperature at the time of starting the vehicle is low work together, even if the power supply system such as the power supply device has no abnormality, the supply voltage may fall below a threshold for determining that the voltage drop is abnormal. The abnormality detection by the voltage drop diagnosis can be prevented from being made in a period during which the voltage supplied to the vehicle control device 1000 is unstable.

By providing the determination S1415 of the voltage drop time not only immediately after the driver performs the power-on operation of the own vehicle, even if an instantaneous voltage drop is erroneously detected due to an influence of an electromagnetic wave or the like, the vehicle control device 1000, power is correctly supplied to the external recognition device 2000, and the like. This enables the operation of the vehicle control function to be continued. On the other hand, when the voltage drop is caused by not noise due to the influence of electromagnetic waves or the like but by an abnormality in the power supply system, the operation of the vehicle control function can be promptly stopped after the lapse of the time set in the determination S1415 of the voltage drop time.

Furthermore, by providing the determination S1416 of the voltage recovery time, after the voltage drop in the period that affects the operation of the vehicle control function is detected and the processing S1417 is executed, the processing S1418 is not executed until the supply voltage can provide the sufficiently stable and normal vehicle control function including the external recognition device 2000 and the actuator 3000, and the abnormal state is continuously maintained. This makes it possible to prevent the vehicle control based on transient and unstable data due to a voltage fluctuation and to prevent the voltage drop diagnosis result from repeatedly changing between abnormal and normal states. In particular, the voltage drop determination time threshold and the voltage recovery determination time threshold can be individually set, and the voltage recovery determination time threshold is set to a value greater than the voltage drop determination time threshold. As a result, the operation of the vehicle control application is promptly stopped when a determination is made that the voltage is abnormal, but the vehicle control is prevented from being performed using transient and unstable data due to a voltage fluctuation when the operation of the vehicle control function is resumed. This can provide safe vehicle control to a driver.

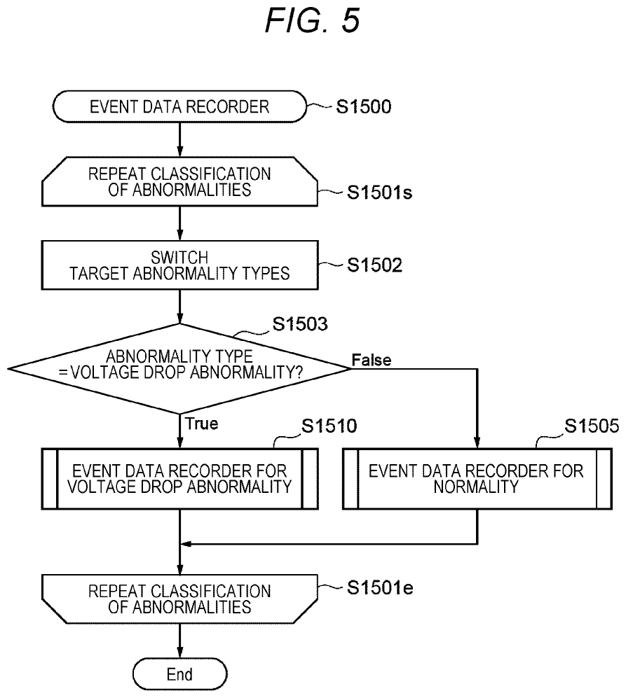

Next, the event data recorder processing S1500 will be described with reference to a flowchart of FIG. 5. The event data recorder processing S1500 is processing for generating the situation at the time of abnormality occurrence detected in the abnormality diagnosis processing S1400 as data for analysis (FED) and storing the analysis data in the nonvolatile memory 1600. In the event data recorder processing S1500, processing from repetitive processing S1501s to repetitive processing S1501e are repeatedly executed by the number of types of abnormalities detected in the abnormality diagnosis processing S1400.

In the repetitive processing, first, the result information about the abnormality diagnosis to be processed or determined by the event data recorder is switched in processing S1502. When the processing S1502 is executed between the repetitive processing S1501s and S1501e, the type of the diagnosis of abnormalities to be processed thereafter is switched to the diagnosis of the communication abnormality related to the camera 2100 determined in the abnormality diagnosis processing S1400 for the first time and to the diagnosis of the communication abnormality related to the radar 2200 for the second time, in accordance with the number of repetitions. Next, in a determination S1503, a determination is made whether the abnormality type of a target abnormality type switched in the processing S1502 is a voltage drop abnormality. When the abnormality type is the voltage drop abnormality, the condition in the determination S1503 is established, and processing S1510, which is an event data recorder for the voltage drop abnormality, is executed. When the abnormality type of the target abnormality type is not the voltage drop abnormality, the condition in the determination S1503 is not established, and processing S1505, which is a normal event data recorder, is executed. The processing then proceeds to the repetitive processing S1501e. In the repetitive processing S1501e, when the repetition has been performed by the number of abnormality types diagnosed in the abnormality diagnosis processing S1400, the event data recorder processing S1500 ends. When, in the repetitive processing S1501e, the repetition has not been completed by the number of the abnormality types diagnosed in the abnormality diagnosis processing S1400, the processing returns to the repetitive processing S1501s to repeatedly execute the processing, and the storage processing of the event data recorder in the processing S1505 or the processing S1510 is executed on all the abnormality types diagnosed in the abnormality diagnosis processing S1400.

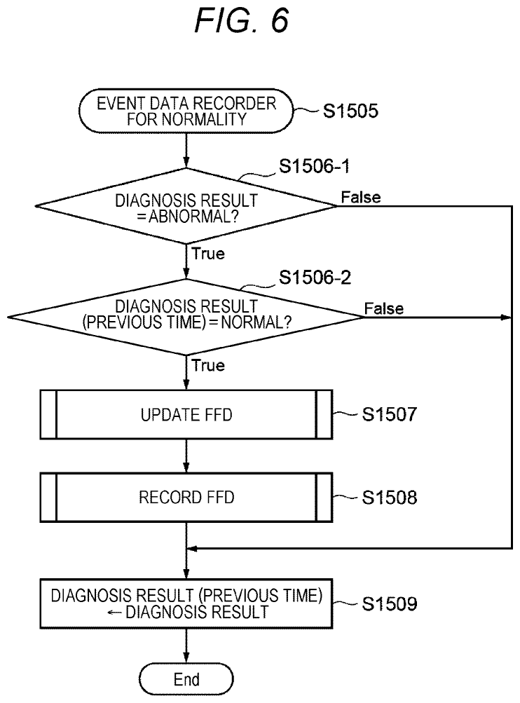

Next, the normal event data recorder in the processing S1505 will be described in detail with reference to a flowchart of FIG. 6. The normal event data recorder in the processing S1505 is processed for each target abnormality type selected in the processing S1502, and analysis data is generated and recorded.

In the normal event data recorder processing S1505, first, a determination is made whether the diagnosis result determined in the abnormality diagnosis processing S1400 is abnormal in a diagnosis result determination S1506-1. When the diagnosis result is abnormal, the condition in determination S1506-1 is established, and the processing proceeds to a determination S1506-2. When the diagnosis result is not abnormal, the condition in the determination S1506-1 is not established, and the processing proceeds to processing S1509. In the determination S1506-2, a determination is made what the diagnosis result is like one cycle before, that is, what the previous value is like. When the previous value of the diagnosis result is a value indicating a normality, the condition in the determination S1506-2 is established, the FFD is updated in processing S1507, and then the FFD updated in the processing S1507 is stored in the non-volatile memory 1600 in processing S1508. The processing proceeds to processing S1509. When the previous value of the diagnosis result is not the value indicating normality in the determination S1506-2, the processing proceeds to S1509. Finally, in the processing S1509, the previous value of the diagnosis result for making a determination in a next cycle under the condition of the determination S1506-2 is updated by setting the diagnosis result.

This configuration makes it possible to detect in the determination S1506-1 and the determination S1506-2 that the result of the abnormality diagnosis processing S1400 has changed from normality to abnormality, to update (collect) the data at the moment as data for analysis in the processing S1507, and to record (save) the data in the nonvolatile memory 1600 in the processing S1508.

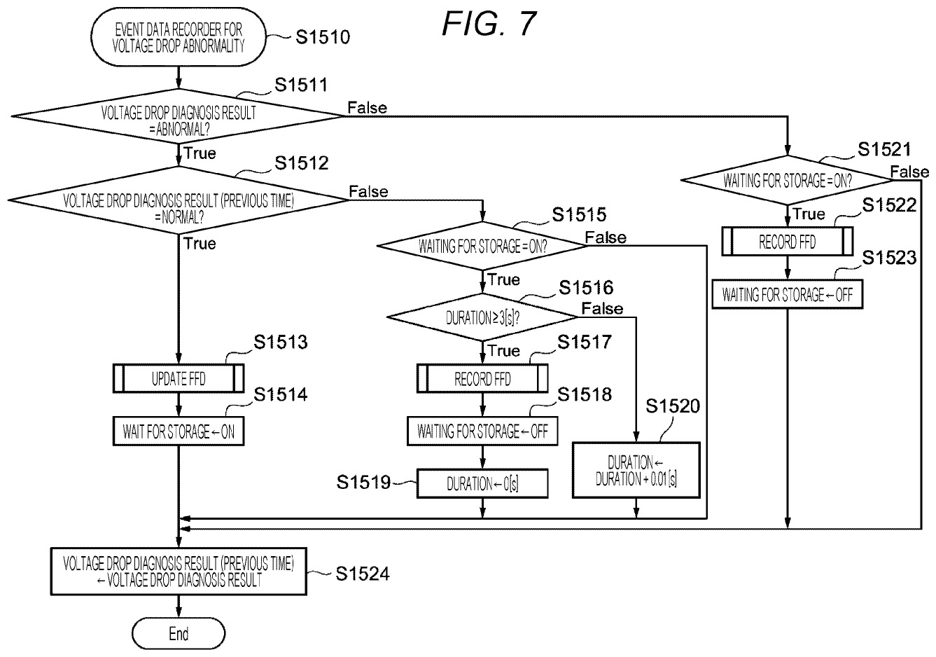

Next, an event data recorder for voltage drop abnormality in the processing S1510 will be described in detail with reference to a flowchart of FIG. 7.

In the event data recorder processing for voltage drop abnormality S1510, first, a determination is made whether the voltage drop diagnosis result is abnormal in a voltage drop diagnosis result determination S1511. When the voltage drop diagnosis result is abnormal, a determination is made that the condition of the determination S1511 is established, and a determination S1512 of the previous voltage drop diagnosis result is made. When the determination S1511 of the voltage drop diagnosis result determination is not established (when normal), waiting for storage (at the time of recovery) determination $1521 is made. In the determination S1512 of the previous result of the voltage drop diagnosis result, when the value one cycle before in the voltage drop diagnosis result (voltage drop diagnosis result (previous time)) is normal, the condition in the determination S1512 is established, FFD update processing S1513 is executed, and waiting for storage is set to ON in processing S1514.

When the condition in the determination S1512 is not established (when the voltage drop diagnosis result (previous time) is abnormal), waiting for storage (abnormality continuation) determination S1515 is made. When the waiting for storage is ON, the condition in the determination S1515 is established, and a duration determination S1516 is made. When the condition in the determination S1515 is not established, the processing and the determination are not performed, and branch processing before the processing S1524 is terminated. When the duration is 3 [s] or more in the duration determination S1516, the condition in the determination S1516 is established, and FFD storage processing S1517 is executed using the FFD information set in the FFD update processing S1513. Thereafter, the waiting for storage is set to OFF in processing S1518, and the duration is set to 0 [s] in processing S1519. When the condition in the duration determination S1516 is not established, a time (for example, 0.01 [s] ) corresponding to the processing cycle is added to the duration in processing S1520.

When the waiting for storage is ON in the waiting for storage (at the time of recovery) determination S1521, the condition in the determination S1521 is established, and FFD storage processing S1522 is executed using the FFD information set in the FFD update processing 1513. Thereafter, the waiting for storage is set to OFF in processing S1523. When the condition in the waiting for storage (at the time of recovery) determination S1521 is not established, the branch processing before the processing S1524 is ended.

When the above-described branch processing before the processing S1524 is completed, finally, as information, which is used in the determination S1512 of the previous result of the voltage drop diagnosis result and is to be used in the next cycle, a value of the voltage drop diagnosis result is set in the voltage drop diagnosis result (previous time) in the processing S1524.

In the event data recorder processing for voltage drop abnormality S1510, a determination is made that the voltage drop diagnosis result has changed from normality to abnormality based on the two branch conditions in the voltage drop diagnosis result determination S1511 and the determination S1512 of the previous result of the voltage drop diagnosis result. When the voltage drop diagnosis result changes from normality to abnormality, the FFD update processing S1513 is executed. As a result, the data at the time when the voltage drop diagnosis result changes from the normal state to the abnormal state is held in the RAM as the most useful data for analyzing the failure cause, the data is not stored in the nonvolatile memory 1600, and the waiting for storage is set to the ON state in the processing S1514. The FFD held in the RAM is then stored in the nonvolatile memory 1600 at one of the following two timings.

The first timing is a case where while the waiting for storage remains in the ON state, the condition of the voltage drop diagnosis result in the determination S1511 is not established and thus the result changes normally. This case means that the voltage has risen and changed to a normal state after a voltage drop is detected once, is a timing indicating that a temporary abnormality has reliably occurred in the power supply circuit and the voltage has dropped, and is a timing at which there is no risk of erroneous detection of a voltage drop. In other words, the timing is such that after the vehicle control function is difficult to perform due to (abnormality caused by) the voltage drop once and the control stop function is performed, the voltage becomes higher than a predetermined voltage (voltage drop determination threshold) with which the vehicle control function is difficult to perform.

The second timing is a case where a certain period of time has elapsed while the waiting for storage is in the ON state and the condition in the duration determination S1516 is established. This case is an event that occurs when the voltage in a low state continues for a certain period of time (for example, 3 [s]) or longer, an expected power supply to the vehicle control device 1000 cannot be obtained because the power generator malfunctions and a high resistance is generated in the power supply system, and the voltage obtained from the power supply device 4000 does not completely decrease even though the power supply is about to be turned off. This case is a timing indicating that the abnormality has reliably occurred. In other words, the timing is such that after the vehicle control function is difficult to perform due to (abnormality caused by) the voltage drop once and the control stop function is performed, a time during which the control stop function is performed (a state where the voltage remains lowered) continues for a certain period time (for example, 3 [s] ) or longer.

In a case where the FFD is left in the nonvolatile memory 1600 at the timing when the voltage drop diagnosis result changes from normal to abnormal using the normal event data recorder processing S1505, the voltage drop is delayed, and thus the abnormality is detected by the voltage drop diagnosis during the time until the shutdown determination is established and the FFD is stored when the driver turns off the power of the vehicle. However, with storage using the system described in the event data recorder processing for voltage drop abnormality S1510 described above, the FFD at the time of occurrence of the abnormality by the power drop diagnosis can be stored without leaking while erroneous storage of the FFD is reduced when the driver turns off the power of the vehicle, and the FFD can be used for the analysis of failure cause.

Next, the processing S1507 for updating FFD, and the contents of FFD used in the processing S1513 will be described. The FFD includes the following data, and makes it possible to grasp the type of detected abnormality, how to use a vehicle, and the situation of load on each component including the vehicle control device 1000. The FFD stored in the non-volatile memory 1600 includes, for example, history information indicating a stop phenomenon of the operation of the control stop function due to an abnormality caused by a voltage drop.
Diagnostic trouble code (DTC) . . . code assigned to each type of failure diagnosis
Post-actuation time of vehicle control device
The number of times of power-ON of the vehicle control device
Supply voltage
Temperature sensor value in the vehicle control device
Odometer value
Shift position
Speed of the own vehicle
Engine speed
Accelerator pedal opening
Brake pedal operation state
Vehicle control application control state
Actuator actuation state
Communication state with actuator and external recognition device

Further, when FFD is recorded in the non-volatile memory 1600, FFD is divided and stored in a plurality of storage regions in consideration of detecting a plurality of types of abnormalities and making abnormality detection many times at different timings. Every time an abnormality is detected in the abnormality diagnosis processing S1400, the abnormalities are stored in the regions allocated for FFD in the non-volatile memory 1600 in order of detecting the abnormalities with the storage regions being shifted. When the abnormalities are detected beyond the upper limit number of the regions allocated for FFD, overwriting is performed on the information about FFD in a manner that the oldest data is overwritten first. As a result, the situation of the occurrence of the abnormalities can be examined retroactively to a plurality of times from the latest failure.

Next, the vehicle control application processing S1100 will be described. In the vehicle control application processing S1100, a control amount and a command value regarding how to operate the actuator 3000 are calculated and processed to be determined based on the information about the external recognition device 2000 and the in-vehicle sensor 6000. At that time, in a case where the result of the voltage drop diagnosis processing S1410 is abnormal, the control function is degenerated, thereby preventing the occurrence of control malfunction.

A specific control function degeneration method will be described using the ACC function for supporting follow-up traveling with respect to a forward traveling vehicle as an example. In ACC, the position of the vehicle (preceding vehicle) in front of an own vehicle is acquired from the external recognition device 2000, and the speed of the own vehicle is increased, decreased, or maintained so that a distance set in advance for each traveling speed of the own vehicle, thereby reducing the driving load due to the driver's operation of the accelerator pedal and the brake pedal. Therefore, if the preceding vehicle decelerates and approaches the own vehicle, ACC instructs the brake 3100 to adjust the control amount for performing deceleration. On the contrary, if the preceding vehicle accelerates and moves away from the own vehicle, ACC instructs the engine 3200 to adjust the control amount for performing acceleration. In such a manner, the speed of the own vehicle is controlled. In a case where an abnormality is detected using the diagnosis function in the vehicle control device 1000 such as the voltage drop diagnosis when a driver is receiving driving assistance from ACC, first, an instruction to display the occurrence of an abnormality is issued to the meter 3500 in order to notify the driver that the abnormality has been detected. This instruction enables the driver to immediately operate the brake pedal and the accelerator pedal to maintain the distance with respect to a preceding vehicle. Further, by switching the instruction of the brake control and the engine control by ACC to the control canceling instruction and transmitting the instruction to the actuator 3000, a brake output and an engine output that hinder driving by the driver are not generated. However, if the brake control is abruptly canceled when an abnormality is detected while the own vehicle is making the brake control due to a short distance with respect to a preceding vehicle, the own vehicle stops the deceleration control before the driver starts to press the brake pedal after the abnormality is detected. This makes the distance between vehicles short, and may cause a danger. Therefore, in the abnormality detection during the brake control, the brake control is not immediately canceled, but the control using the brake is canceled while being gradually weakened. Specifically, a control command value is calculated and an instruction is provided to the brake so that the deceleration decreases by 0.02 [G] every 0.01 [s]. If the brake control is made at the deceleration of 0.3 [G], for example, the deceleration by the brake becomes 0 [G] after 1.5 [s] from abnormality occurrence, and the brake control is canceled. In such a manner, the ACC control is degenerated so that the distance between vehicles is not too short.

Thus, in the vehicle control processing 1000, the supply voltage of the vehicle control device 1000 is monitored and diagnosed, FFD is generated when an abnormality is detected by the voltage drop diagnosis, and the vehicle control application (vehicle control function) is degenerated and stopped. Further, FFD can be stored in the nonvolatile memory 1600 only when an abnormality caused by a voltage drop due to a cause different from the power-off operation of the vehicle by the driver is detected.

### First Modification

The above-described event data recorder processing for voltage drop abnormality S1510 can also be modified as follows.

In modified event data recorder processing for voltage drop abnormality S1510-B, an estimation is made that a problem occurs in the power supply system of the own vehicle, and increases the timing to record FFD. Therefore, the event data recorder 1500 of the present modification includes a voltage drop estimation unit that estimates that the voltage supplied from the power supply system of the own vehicle is likely to drop within a certain period of time (for example, 2 [s]) until the control stop function is performed. When the voltage drop estimation unit estimates the occurrence of the voltage drop, FFD is stored in the nonvolatile memory 1600. For example, the voltage drop estimation unit estimates that an accident occurs in the own vehicle, an abnormality occurs in the power supply system, and a voltage drop occurs.

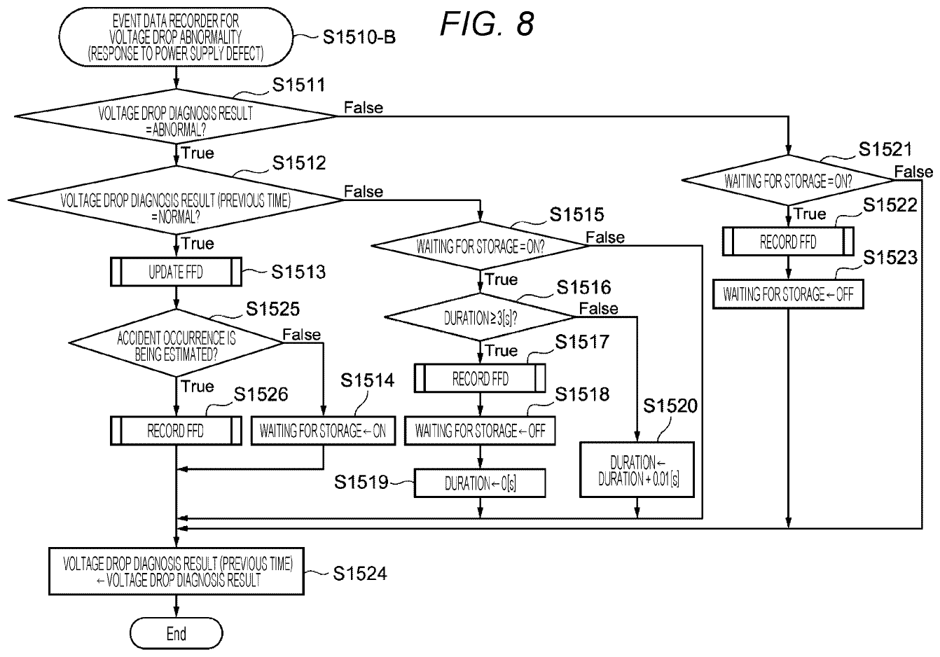

A specific modification of the event data recorder processing for voltage drop abnormality S1510-B will be described with reference to the flowchart (in response to a power supply failure) in FIG. 8. Instead of executing the processing S1514 after the FFD update processing S1513 to set ON in the memory standby state in the processing S1510 illustrated in the flowchart of FIG. 7, in the modified event data recorder processing for voltage drop abnormality S1510-B, a determination is made in a determination S1525 whether an estimation is made that the probability of occurrence of a problem in the power supply system of the own vehicle increases. In the determination S1525, the determination is made whether the probability of occurrence of a problem in the power supply system of the own vehicle is estimated to be high based on whether the possibility of occurrence of an accident in the own vehicle is estimated to be high. When the estimation is made that an accident is highly likely to occur in the own vehicle, the condition in the determination S1525 is satisfied, processing S1526 is executed, and the FFD generated in the FFD update processing S1513 is immediately stored in the nonvolatile memory 1600. In a case where the estimation is made that an accident is highly likely to occur in the own vehicle, the processing S1514 is executed to set the waiting for storage to ON, similarly to the event data recorder processing for voltage drop abnormality S1510.

At this time, as a condition for performing the accident occurrence estimation in the determination S1525, specifically, in a case where any one of the following conditions is established within a certain period of time (for example, 2 [s]) from the time when the determination S1525 is made, accident occurrence is being estimated.
Air back operation of own vehicle
A collision prediction time (relative distance: relative speed) between the own vehicle and a three-dimensional object including a vehicle, a pedestrian, a wall, and the like detected by the external recognition device 2000 is shorter than a certain value.
The prediction time (relative distance÷relative speed) until the own vehicle enters a road shoulder including a cliff, a sea, a river, and the like detected by the external recognition device 2000 is shorter than a certain value.
At the time when the vehicle control application 1100 is warning driver of a collision with a three-dimensional object
The control instruction to brake 3100 or the electric power steering 3400 for the purpose of avoiding or reducing collision damage is being executed by vehicle control application 1100
At the time when the vehicle control application 1100 is warning a driver of lane departure
The control instruction to the brake 3100 or the electric power steering 3400 for the purpose of avoiding lane departure or reducing a departure speed is being executed by vehicle control application 1100.

That is, the voltage drop estimation unit (determination S1525) of the present modification includes a determination (estimation) establishing condition that the accident damage avoidance and reduction vehicle control function for the purpose of avoiding or reducing damage due to an accident of an own vehicle is in operation (being performed) by the vehicle control device 1000. The accident damage avoidance and reduction vehicle control function is collision avoidance and reduction automatic brake control, collision avoidance and reduction automatic steering control, driving force suppression control related to erroneous pressing of the accelerator pedal mistake, and the like.

The configuration to which this modification is applied makes it possible to prevent a collision accident or a fall accident from occurring, while either the FFD storage processing S1517 nor the FFD storage processing S1522 is unable to be execute although the diagnosis result in the voltage drop diagnosis processing S1410 indicates abnormality, the power supply system of the own vehicle from being damaged, the power supply to the vehicle control device 1000 from being cut off (power failure), and FFD during occurrence of the voltage drop abnormality from being unable to left in the vehicle control device 1000.

### Second Modification

The event data recorder processing for voltage drop abnormality S1510 and the event data recorder processing for voltage drop abnormality S1510-B can be modified as follows. In modified event data recorder processing for voltage drop abnormality S1510-C, an estimation is made that a voltage fluctuation occurs in the power supply system of an own vehicle, and the timing to record FFD is increased.

The event data recorder processing for voltage drop abnormality S1510-C is configured to determine that the determination S1525 is established and execute the FFD storage processing S1526 even in a case where the condition of the voltage fluctuation estimation for estimating that a voltage fluctuation occurs in the power supply system of an own vehicle is added to the condition of the determination S1525 added in the event data recorder processing for voltage drop abnormality S1510-B and an estimation is made that the voltage fluctuation occurs. As a condition of the voltage fluctuation estimation, the voltage fluctuation during the operation of the vehicle control application 1100 is measured in the design stage in advance, and when a control instruction with large power consumption is issued within a certain period of time (for example, 2 [s]) from the time when the determination S1525 is performed, a determination is made that the voltage fluctuation occurs. Examples of the automatic brake control by AEB include power use for moving a motor used to increase the deceleration of the vehicle, power use for moving an electric power steering by AES, and a starter drive instruction for starting the engine that has stopped idling before starting from the stop state by ACC.

That is, in accordance with an actuator control instruction from the vehicle control device 1000, the voltage drop estimation unit (determination S1525) of the present modification includes a determination (estimation) establishing condition that a power using vehicle control function that consumes power to operate the actuator 3000 is in operation (being performed) by the vehicle control device 1000, and estimates that a voltage drop occurs in the power supply system, based on the determination (estimation) establishing condition including that. The power using vehicle control function operates a brake device, an electric power steering device, an engine starter, a motor device for vehicle acceleration and deceleration, and the like of an own vehicle.

This configuration makes it possible to prevent the power supply to the vehicle control device 1000 from being cut off without executing any of the FFD storage processing S1517 and the FFD storage processing S1522 although the diagnosis result in the voltage drop diagnosis processing S1410 indicates an abnormality when the entire vehicle consumes a large amount of power, and FFD from being unable to be left.

In addition, the condition of the voltage fluctuation estimation can be applied simultaneously with the determination during the accident occurrence estimation described in the first modification, and only the condition of the voltage fluctuation estimation can be applied without applying the accident occurrence estimation.

### Third Modification

Although the vehicle control device 1000 described in the present embodiment has been described as a component that executes the application for making the vehicle control, the programs or the functions applied to the vehicle control device 1000 can be integrated in any of the external recognition device 2000 and the actuator 3000. For example, in the configuration, the vehicle control device 1000 and the camera 2100 are integrated, the camera 2100 executes the abnormality diagnosis processing S1400 while performing the calculation for the vehicle control application such as ACC and AEB, and transmits a control instruction value for the vehicle operation to the actuator 3000. The function of the vehicle control device 1000 is mounted in the microprocessor built in the brake 3100, and while the brake 3100 receives data from the external recognition device 2000 and performs calculation for the vehicle control applications such as ACC and AEB, the abnormality diagnosis processing S1400 can also be executed and the control instruction value can be transmitted to the engine 3200 and the meter 3500. Further, the vehicle control device 1000 may be divided into a plurality of parts and applied. For example, the vehicle control device 1000 is divided into a vehicle control device 1000-A and a vehicle control device 1000-B. A vehicle control application for controlling the longitudinal acceleration of a vehicle, such as AEB and ACC, is mounted into the vehicle control device 1000-A. A vehicle control application for controlling the steering of a vehicle, such as LKS, is mounted into the vehicle control device 1000-B. The abnormality diagnosis processing S1400 and the event data recorder processing S1500 can be applied to each vehicle control device. Therefore, the present embodiment is not limited to a case where one vehicle control device is mounted as one component to a vehicle.

### SUMMARY

As described above, the vehicle control device 1000 according to the present embodiment that controls an own vehicle by performing (vehicle control function) achieved by (receiving power supplied from one power supply and) a plurality of control devices (1000, 2000, 3000, and 6000) that share one power supply (power supply device 4000) includes a voltage measurement unit (voltage acquisition unit 1200) that measures a voltage of the power supply, the abnormality diagnosis unit 1400 that has the control stop function of determining whether the control function achieved by the plurality of control device is difficult to perform due to a voltage drop (compared to a voltage drop determination threshold) of the power supply and stopping the control in a case where the function is difficult to perform, and the storage instruction unit (event data recorder 1500) that instructs the storage unit (nonvolatile memory 1600) to store history information (FFD) indicating a stop phenomenon of an operation (control) by the control stop function. The storage instructing unit (event data recorder 1500) instructs the storage unit (FFD storage processing S1522) to store the history information therein in a case where the voltage of the power supply becomes higher than a predetermined voltage (voltage drop determination threshold) at which the control functions are difficult to perform (False in the voltage drop diagnosis result determination S1511) after the control stop function is performed.

The storage instructing unit (event data recorder 1500) instructs the storage unit (FFD storage processing S1517) to store the history information therein when a time (a state where the voltage remains low) in which the control stop function is performed continues for a certain period of time (for example, 3 [s]) or longer (True in the duration determination S1516) after the control stop function is performed.

The storage instruction unit (event data recorder 1500) includes a voltage drop estimation unit (determination S1525) that estimates that a voltage supplied from a power supply system of the own vehicle is likely to drop within a certain period of time (for example, 2 [s] ) until the control stop function is performed, and instructs the storage unit to store the history information therein (FFD storage processing S1526) in a case where the voltage drop estimation unit (determination S1525) estimates occurrence of the voltage drop (True in the determination S1525).

The voltage drop estimation unit (determination S1525) estimates that an accident occurs in the own vehicle, an abnormality occurs in the power supply system, and a voltage drop occurs.

That is, the vehicle control device 1000 according to the present embodiment stops vehicle control function and generates the analysis data (FFD) at the same time when detecting the supply voltage drop, and records the analysis data (FFD) in the nonvolatile memory 1600 at any timing when the abnormality is eliminated by the detection of voltage rise or when the duration of the voltage drop reaches a certain period of time or longer.

Further, the present invention also includes analysis data storage timing control that, when a supply voltage drop is detected during the performing a vehicle control function with which the damage of the power supply system is predicted or during performing the vehicle control function that causes a great voltage fluctuation within a certain period of time until the vehicle control function is stopped, generates analysis data (FFD) and then immediately stores the analysis data (FFD) in the nonvolatile memory 1600.

According to the vehicle control device 1000 of the present embodiment, analysis data is accurately recorded when an abnormal voltage drop is detected, and erroneous storage of analysis data due to a driver's power-off operation can be prevented. Then, when abnormality of the vehicle is analyzed, analysis data during abnormality occurrence, the analysis data being most useful for investigating a cause of the abnormality, can be obtained without necessary analysis data loss caused by push-out from a memory due to unnecessary analysis data.

In further summary of the present invention, in the storage of abnormality cause analysis data in the vehicle control device 1000, there arises a problem that a voltage drop, which is caused by a power-off operation by a driver due to a variation in charge and discharge characteristics that change depending on types and a number of in-vehicle electronic components and electric components, is determined as a voltage drop caused by occurrence of a power supply abnormality, and stored as analysis data, and data useful for a failure cause analysis cannot be acquired due to overwriting.

In cope with the above problem, a vehicle control device 1000 according to the present embodiment stops a vehicle control function and generates analysis data (FFD) when detecting a supply voltage drop, and records the analysis data (FFD) in a nonvolatile memory 1600 at any of timing of eliminating an abnormality due to a detection of a voltage rise, timing when a duration of the voltage drop reaches a certain period of time or longer, timing when the vehicle control function of predicting damage of a power supply system is performed within a certain period of time until the vehicle control function is stopped, and timing when the vehicle control function in which a large voltage fluctuation occurs is performed within a certain period of time until the vehicle control function is stopped.

According to the vehicle control device 1000 of the present embodiment, even if charge and discharge characteristics vary depending on the types and the number of mounted in-vehicle electronic components and electric components, erroneous analysis data is not recorded by the driver's power-off operation, and only analysis data during the detection of an abnormal voltage drop can be accurately recorded, and the cause of abnormality occurrence can be easily analyzed.

Note that the present invention is not limited to the above-described embodiment, and includes various modifications. For example, the above-described embodiment has been described in detail for easy understanding of the present invention, and the present invention is not necessarily limited to an invention having all the described configurations.

Some or all of the above-described configurations, functions, processing units, processing means, and the like may be achieved by hardware, for example, by designing with an integrated circuit. In addition, each of the above-described configurations, functions, and the like may be achieved by software with which a processor interprets and executes programs for realizing functions. Information such as a program, a table, and a file for achieving each function can be stored in a recording device such as a memory, a hard disk, and a solid state drive (SSD), or a recording medium such as an integrated circuit (IC) card, a secure digital (SD) card, and a digital versatile disc (DVD).

In addition, control lines and information lines that are considered to be necessary for the description are indicated, and not all control lines and information lines on a product are indicated. In practice, it may be considered that almost all the configurations are connected to each other.

### Reference Signs List

1000 vehicle control device
1100 vehicle control application
1200 voltage acquisition unit (voltage measurement unit)
1300 shutdown processing unit
1400 abnormality diagnosis unit
1500 event data recorder (storage instructing unit)
1600 nonvolatile memory (storage unit)
2000 external recognition device
2100 camera
2200 radar
2300 sonar
3000 actuator
3100 brake
3200 engine
3300 transmission
3400 electric power steering
3500 meter
4000 power supply device
5000 analysis device
6000 in-vehicle sensor

1. A vehicle control device that controls an own vehicle by performing control functions realized by a plurality of control devices that shares one power supply, the vehicle control device comprising:
a voltage measurement unit that measures a voltage of the power supply;
an abnormality diagnosis unit having a control stop function of determining whether the control functions achieved by the plurality of control devices are difficult to perform due to a voltage drop of the power supply and stopping the control in a case where the functions are difficult to perform; and
a storage instruction unit that instructs a storage unit to store history information indicating a stop phenomenon of an operation in the control stop function therein,
wherein the storage instruction unit instructs the storage unit to store the history information therein in a case where a voltage of the power supply becomes higher than a predetermined voltage at which the control functions are difficult to perform after the control stop function is performed.

2. The vehicle control device according to claim 1, wherein the storage instruction unit instructs the storage unit to store the history information therein in a case where a time during which the control stop function is performed continues for a certain period of time or more after the control stop function is performed.

3. The vehicle control device according to claim 1, wherein the storage instruction unit includes a voltage drop estimation unit that estimates that a voltage supplied from a power supply system of the own vehicle is likely to drop within a certain period of time until the control stop function is performed, and instructs the storage unit to store the history information therein in a case where the voltage drop estimation unit estimates occurrence of the voltage drop.

4. The vehicle control device according to claim 3, wherein the voltage drop estimation unit estimates that an accident occurs in the own vehicle, an abnormality occurs in the power supply system, and a voltage drop occurs.

5. The vehicle control device according to claim 4, wherein the voltage drop estimation unit includes a determination establishing condition that an accident damage avoidance and reduction vehicle control function for a purpose of avoiding or reducing damage due to an accident of the own vehicle is being performed by the vehicle control device.

6. The vehicle control device according to claim 3, wherein the voltage drop estimation unit includes a determination establishing condition that a power using vehicle control function that consumes power to operate an actuator is being performed by the vehicle control device in response to an actuator control instruction from the vehicle control device, and estimates that a voltage drop occurs in the power supply system, based on the determination establishing condition.

7. The vehicle control device according to claim 5, wherein the accident damage avoidance and reduction vehicle control function is any of collision avoidance and reduction automatic brake control, collision avoidance and reduction automatic steering control, and driving force suppression control due to erroneous pressing of an accelerator pedal.

8. The vehicle control device according to claim 6, wherein the power using vehicle control function operates any of a brake device, an electric power steering device, an engine starting device, and a vehicle acceleration and deceleration motor device of the own vehicle.
